(19) United States
(12) Patent Application Publication
(10) Pub. No.: US 2023/0225458 A1
(43) Pub. Date: Jul. 20, 2023

(54) THREE-DIMENSIONAL FLEXING RESISTANCE WATERPROOF AND MOISTURE-PERMEABLE SHOE UPPER AND PREPARATION METHOD THEREFOR

(71) Applicant: FUJIAN RUIHONG TEXTILE TECHNOLOGY CO., LTD., Fuqing City (CN)

(72) Inventors: Jianliang SHI, Fuqing City (CN); Minghui LIN, Fuqing City (CN)

(73) Assignee: FUJIAN RUIHONG TEXTILE TECHNOLOGY CO., LTD., Fuqing City (CN)

(21) Appl. No.: 17/880,693

(22) Filed: Aug. 4, 2022

(30) Foreign Application Priority Data
Jan. 19, 2022 (CN) 202210057706.6

(51) Int. Cl. A43B 23/02

(52) U.S. Cl. CPC A43B 23/0235; A43B 23/0255

(57) ABSTRACT

A three-dimensional flexing resistance waterproof and moisture-permeable shoe upper, including fabric, waterproof and moisture-permeable membrane, and eco-friendly adhesive is provided. The waterproof and moisture-permeable membrane is closely bonded with an inner layer of the fabric. The outer layer and inner layer of the fabric are closely bonded together through eco-friendly adhesive, which is bonded with the fabric in a mesh structure. The eco-friendly adhesive includes liquid adhesive or powder adhesive. The shoe upper is shaped by the heating method which includes vacuum heating, electric heating or steam heating. The outer layer of the fabric is closely bonded with the inner layer, so that the defects of the accumulation of sludge, dust and water droplets between the outer layer and the inner layer of the existing shoe upper is overcome, making the shoe upper waterproof and moisture permeable. The three-dimensional shoe upper is formed through vacuum forming method.

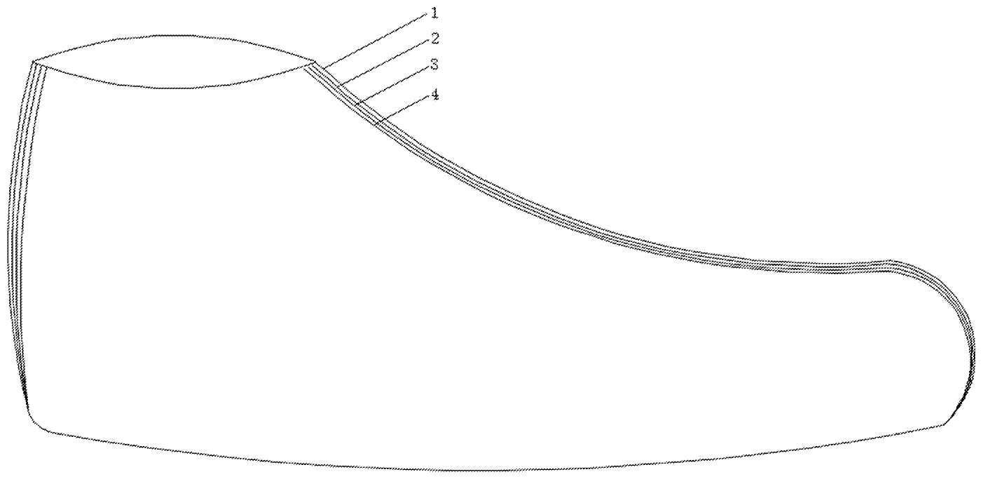

### TECHNICAL FIELD

The invention relates to the shoe upper field, in particular to a three-dimensional flexing resistance waterproof and moisture-permeable shoe upper and preparation method therefor.

### BACKGROUND

The existing waterproof and moisture permeable shoe upper is generally used by combining the fabric with the waterproof membrane. Some of them directly bond the waterproof membrane with the fabric through glue to form a waterproof shoe upper, which has a good waterproof effect, but the glue is bonded to all fabric surfaces, resulting in impermeability. After wearing for several hours, the foot microenvironment is relatively humid and uncomfortable. In some cases, the waterproof membrane is bonded with the inner layer or hosiery, and then stitched together with the outer fabric after being overlapped, which has a certain waterproof and moisture permeable effect. However, the inner layer or hosiery is not closely connected with the outer fabric in the middle, which is separated, and sludge and water droplets are very easy to gather in the separation space. After wearing for a period of time, the waterproof and moisture permeable effect becomes worse, which seriously affects the sense of wearing. The existing waterproof and moisture permeable shoe upper is generally of planar structure. When processing, shoe factories need to add vulcanization tank for hot pressing or use high-cost aluminum shoe lasts with good thermal conductivity for hot air shaping. The processes are many and cumbersome, and the quality operation requires proficiency.

Chinese patent CN201811014191.1 relates to a forming method of waterproof and moisture permeable shoe upper and its shoe upper, which includes a set of setting steps. A shoe upper and a waterproof and moisture permeable membrane are sleeved on a shoe last, wherein at least one of the shoe upper and the waterproof and moisture permeable membrane contains microwave treatable materials. And a heating and shaping step, the microwave heating sleeve is provided with the upper and the last of the waterproof and moisture permeable film, so as to bond the upper with the waterproof and moisture permeable film through the microwave treatable material, and cool and shape to form the waterproof and moisture permeable upper. In terms of technology, the shoe upper and the waterproof and moisture permeable membrane are wrapped on the shoe last and heated. The process is relatively cumbersome, and it is difficult to control the alignment and air gap of the shoe upper, the waterproof and moisture permeable membrane and the shoe last in the processing process. In terms of effect, the waterproof and moisture permeable membrane has a certain moisture permeable effect, but it is not mentioned whether it is durable after compounding with the shoe upper, and whether it is waterproof and moisture permeable after repeated wearing and washing.

Chinese patent CN201310412351.9 discloses a preparation method of waterproof and moisture permeable membrane, which includes the following steps: dissolving hydrophobic polymer in the first spinning solvent to obtain hydrophobic spinning solution. First electrospinning the hydrophobic spinning solution to obtain a single-layer waterproof and moisture permeable film; or dissolve the hydrophilic polymer in the second spinning solvent to obtain a hydrophilic spinning solution. The hydrophilic spinning solution is electrospinned for the second time to obtain a hydrophilic nanofiber film. The single-layer waterproof and moisture permeable membrane is compounded with hydrophilic nanofiber membrane to obtain a double-layer waterproof and moisture permeable membrane.

Chinese patent CN201922017824.0 discloses a PU/TPU two-component waterproof and moisture permeable membrane, including TPU waterproof and moisture permeable membrane and PU waterproof and moisture permeable membrane arranged on one side of TPU waterproof and moisture permeable membrane. The double-layer setting of PU waterproof and moisture permeable membrane and TPU waterproof and moisture permeable membrane can effectively reduce the production cost of the whole waterproof and moisture permeable membrane, and maintain the appearance and hand feel of PU waterproof and moisture permeable membrane. Due to the environmental protection of the production process of TPU waterproof and moisture permeable membrane. When producing two-component waterproof and moisture permeable membrane, it can reduce the content of DMF and is beneficial to the environment.

Chinese patent CN201220289118.7 discloses a new waterproof and moisture permeable composite fabric, which is characterized in that: from the outside to the inside, it successively includes the fabric body, the outer waterproof and moisture permeable layer, the mesh cloth, the inner waterproof and moisture permeable layer and the inner layer of the fabric. The upper and lower surfaces of the outer waterproof and moisture permeable layer and the inner waterproof and moisture permeable layer are provided with a hot-melt adhesive layer, which is distributed in dots, and the fabric body, waterproof and moisture permeable layer, mesh cloth, the inner waterproof and moisture permeable layer and the inner layer of the fabric are bonded layer by layer through a hot-melt adhesive layer. The outer waterproof and moisture permeable layer and the inner waterproof and moisture permeable layer are both polytetrafluoroethylene resin film layers. The waterproof and moisture permeable composite fabric makes full use of the waterproof and moisture permeable properties of the polytetrafluoroethylene resin film and realizes the function of keeping warm at the same time. The clothes and raincoats made can keep the body dry and comfortable.

### SUMMARY

The object of the invention is to overcome the deficiency of the prior art and provides a three-dimensional flexing resistance waterproof and moisture-permeable shoe upper.

The object of the invention is realized through the following technical scheme: a three-dimensional flexing resistance waterproof and moisture-permeable shoe upper, which comprises fabric, waterproof and moisture-permeable membrane, and eco-friendly adhesive. The fabric includes outer layer and inner layer. The waterproof and moisture-permeable membrane is closely bonded with the inner layer of the fabric. The outer layer and inner layer of the fabric are closely bonded together through eco-friendly adhesive. The eco-friendly adhesive is bonded with the fabric in a mesh structure. The eco-friendly adhesive includes liquid adhesive or powder adhesive. The shoe upper is shaped by heating, and the heating methods include vacuum heating, electric heating or steam heating.

In some embodiment, the inner layer of the fabric comprises two pieces of fabric, the waterproof and moisture-permeable membrane is closely bonded between the two pieces of fabric in the inner layer of the fabric through heat sealing, and the eco-friendly adhesive is bonded to the connection between the inner layer of the fabric and the outer layer of the fabric in a mesh structure.

In some embodiment, the two pieces of fabric in the inner layer of the fabric comprise an inner layer of the fabric in contact with outer layer of the fabric and an inner layer of the fabric closest to the instep. In the hot-melt state, the eco-friendly adhesive is bonded to the inner layer of the fabric in contact with outer layer of the fabric in a mesh structure. After the bonding is completed, the eco-friendly adhesive in the mesh structure is cooled, solidified and tightly bonded to the fabric under the room temperature.

In some embodiment, the mesh structure includes lattice and rhombic, and the eco-friendly adhesive forms the edges of the lattice and rhombic.

In some embodiment, the shoe upper is sleeved outside the shoe last of the corresponding specification to form a 3D assembly, and the 3D assembly is heated and shaped by a vacuum forming method to obtain a three-dimensional shaped upper.

In some embodiment, from the outside to the inside, the shoe upper comprises the outer layer of the fabric, the inner layer of the fabric in contact with outer layer of the fabric, the waterproof and moisture-permeable membrane, and the inner layer of the fabric closest to the instep. The shoe upper is sleeved outside the shoe last of the corresponding specification to form a 3D assembly. The 3D assembly is heated by a vacuum forming method. The eco-friendly adhesive melts when heated, and is closely bonded with the fabric and the waterproof and moisture-permeable membrane.

In some embodiment, the outer layer of the fabric has anti-wicking treatment.

In some embodiment, the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure. The flat woven or knitted fabric comprises seamless fabric.

The invention also provides a method for preparing a three-dimensional flexing resistance waterproof and moisture-permeable shoe upper, comprising: step (1), preparing the above-mentioned outer layer of the fabric, the waterproof and moisture-permeable membrane and the inner layer of the fabric; step (2), performing anti-wicking treatment on the outer layer of the fabric; step (3), the waterproof and moisture-permeable membrane is closely bonded between the two pieces of fabric in the inner layer of the fabric through heat sealing; step (4), In the hot-melt state, the eco-friendly adhesive is bonded to the inner layer of the fabric in contact with outer layer of the fabric in a mesh structure. After the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by a vacuum forming method, the eco-friendly adhesive melts when heated, and is closely bonded with the fabric and the waterproof and moisture-permeable membrane.

In some embodiment, in the vacuum forming method a heating temperature is 100° C.-300° C., and a heating time is 10 s-100 s.

Compared with the prior art, the beneficial effects of the invention are:

(1) Due to the eco-friendly adhesive pasted and formed in the mesh structure, the inner layer and the outer layer are bonded tightly together. In addition, the moisture is permeable via the gaps of the mesh structure. Thus, the outer layer of the fabric is closely bonded with the inner layer, which overcomes the technical defects of the accumulation of sludge, dust and water droplets caused by the separation of the outer layer and the inner layer of the existing shoe upper, and can keep the shoe upper continuously and effectively waterproof and moisture permeable.

(2) The three-dimensional shoe upper is formed by vacuum forming method. The forming effect is good, which is convenient for the subsequent processing of finished shoes.

### BRIEF DESCRIPTION OF THE DRAWING

The drawing is a structural diagram of three-dimensional flexing resistance waterproof and moisture-permeable shoe upper according to the invention.

### DETAILED DESCRIPTION

The invention will now be further described with embodiments.

### Embodiment 1

A three-dimensional flexing resistance waterproof and moisture-permeable shoe upper, which comprises fabric, waterproof and moisture-permeable membrane 3, and eco-friendly adhesive. The fabric includes outer layer 1 and inner layers 2, 4. The waterproof and moisture-permeable membrane 3 is closely bonded with the inner layers 2, 4 of the fabric. The outer layer 1 and inner layer 2 of the fabric are closely bonded together through eco-friendly adhesive. The eco-friendly adhesive is bonded with the fabric in a mesh structure. The eco-friendly adhesive includes liquid adhesive or powder adhesive. The shoe upper is shaped by heating, and the heating methods include vacuum heating, electric heating or steam heating.

In some embodiment, the inner layer of the fabric comprises two pieces of fabric, the waterproof and moisture-permeable membrane 3 is closely bonded between the two pieces of fabric in the inner layer of the fabric through heat sealing, and the eco-friendly adhesive is bonded to the connection between the inner layer of the fabric and the outer layer 1 of the fabric in a mesh structure. Thus, due to the eco-friendly adhesive pasted and formed in the mesh structure, the inner layer and the outer layer are bonded tightly together. In addition, the moisture is permeable via the gaps of the mesh structure.

In some embodiment, the two pieces of fabric in the inner layer of the fabric comprise an inner layer 2 of the fabric in contact with outer layer 1 of the fabric and an inner layer 4 of the fabric closest to the instep. In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature.

In some embodiment, the mesh structure includes lattice and rhombic, and the eco-friendly adhesive forms the edges of lattice and rhombic.

In some embodiment, the shoe upper is sleeved outside the shoe last of the corresponding specification to form a 3D assembly, and the 3D assembly is heated and shaped by the vacuum forming method to obtain a three-dimensional shaped upper.

In some embodiment, the outer layer 1 of the fabric has anti-wicking treatment.

In some embodiment, the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure. The flat woven or knitted fabric comprises seamless fabric.

In some embodiment, the dense structure is warp knitted closed pillar stitch, and 75 d recycled polyester fiber filaments are fully knitted under the guidance of a guard bar. The small mesh structure, the medium mesh structure and the large mesh structure are not directly connected, but are transiently connected through a dense structure. In some embodiment, the transition connection section is ≥2 loop column widths or 2 loop column lengths. And, the inner fabric is a light and thin fabric with Martindale abrasion resistance≥20000 revolutions. The small mesh structure, the medium mesh structure and the large mesh structure are warp knitted by the combination of two half jacquard guard bars and a conventional guard bar guiding 75 d-300 d recycled polyester fiber filament. The mesh length of the small mesh structure, the medium mesh structure and the large mesh structure differs by at least one loop column width or one loop column length.

The invention also provides a method for preparing a three-dimensional flexing resistance waterproof and moisture-permeable shoe upper, comprising: step (1), preparing the above-mentioned outer layer 1 of the fabric, the waterproof and moisture-permeable membrane 3 and the inner layers 2, 4 of the fabric; step (2), performing anti-wicking treatment on the outer layer 1 of the fabric; step (3), the waterproof and moisture-permeable membrane 3 is closely bonded between the two pieces of fabric in the inner layer of the fabric through heat sealing; step (4), In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by the vacuum forming method, the eco-friendly adhesive melts when heated, and is closely bonded with the fabric and the waterproof and moisture-permeable membrane 3.

In some embodiment, in the vacuum forming method a heating temperature is 180° C., and a heating time is 30 s.

### Embodiment 2

A three-dimensional flexing resistance waterproof and moisture-permeable shoe upper, which comprises fabric, waterproof and moisture-permeable membrane 3, and eco-friendly adhesive. The fabric includes outer layer 1 and inner layer 2, 4. The waterproof and moisture-permeable membrane 3 is closely bonded with the inner layer s 2, 4 of the fabric. The outer layer 1 and inner layer 2 of the fabric are closely bonded together through eco-friendly adhesive. The eco-friendly adhesive is bonded with the fabric in a mesh structure. The eco-friendly adhesive includes liquid adhesive or powder adhesive. The shoe upper is shaped by heating, and the heating methods include vacuum heating, electric heating or steam heating.

In some embodiment, the inner layer of the fabric comprises two pieces of fabric, the waterproof and moisture-permeable membrane 3 is closely bonded between the two pieces of fabric in the inner layer of the fabric through heat sealing, and the eco-friendly adhesive is bonded to the connection between the inner layer of the fabric and the outer layer 1 of the fabric in a mesh structure.

In some embodiment, the two pieces of fabric in the inner layer of the fabric comprise an inner layer 2 of the fabric in contact with outer layer 1 of the fabric and an inner layer 4 of the fabric closest to the instep. In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature. Thus, due to the eco-friendly adhesive pasted and formed in the mesh structure, the inner layer and the outer layer are bonded tightly together. In addition, the moisture is permeable via the gaps of the mesh structure.

In some embodiment, the mesh structure includes lattice and rhombic, and the eco-friendly adhesive forms lattice and rhombic edges.

In some embodiment, from the outside to the inside, the shoe upper comprises the outer layer 1 of the fabric, the inner layer 2 of the fabric in contact with outer layer 1 of the fabric, the waterproof and moisture-permeable membrane 3, and the inner layer 4 of the fabric closest to the instep. The shoe upper is sleeved outside the shoe last of the corresponding specification to form a 3D assembly. The 3D assembly is heated by the vacuum forming method. The eco-friendly adhesive melts when heated, and is closely bonded with the fabric and the waterproof and moisture-permeable membrane 3.

In some embodiment, during the anti-wicking treatment, the fabric is immersed in the waterproof treatment liquid and then extruded by the pressure roller, the amount of waterproof agent in the waterproof treatment liquid is 60 g/L, the fabric is dried after waterproof treatment, and the drying temperature is 140° C.

In some embodiment, the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure. The flat woven or knitted fabric comprises seamless fabric.

In some embodiment, the dense structure is warp knitted closed pillar stitch, and 75 d recycled polyester fiber filaments are fully knitted under the guidance of a guard bar. The small mesh structure, the medium mesh structure and the large mesh structure are not directly connected, but are transiently connected through a dense structure. In some embodiment, the transition connection section is ≥2 loop column widths or 2 loop column lengths. And, the inner fabric is a light and thin fabric with Martindale abrasion resistance≥20000 revolutions. The small mesh structure, the medium mesh structure and the large mesh structure are warp knitted by the combination of two half jacquard guard bars and a conventional guard bar guiding 75 d-300 d recycled polyester fiber filament. The mesh length of the small mesh structure, the medium mesh structure and the large mesh structure differs by at least one loop column width or one loop column length.

The invention also provides a method for preparing a three-dimensional flexing resistance waterproof and moisture-permeable shoe upper, comprising: step (1), preparing the above-mentioned outer layer 1 of the fabric, the waterproof and moisture-permeable membrane 3 and the inner layers 2, 4 of the fabric; step (2), performing anti-wicking treatment on the outer layer 1 of the fabric; step (3), the waterproof and moisture-permeable membrane 3 is closely bonded between the two pieces of fabric in the inner layer of the fabric through heat sealing; step (4), In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by the vacuum forming method, the eco-friendly adhesive melts when heated, and is closely bonded with the fabric and the waterproof and moisture-permeable membrane 3.

In some embodiment, in the vacuum forming method a heating temperature is 100° C., and a heating time is 100 s.

### Embodiment 3

A three-dimensional flexing resistance waterproof and moisture-permeable shoe upper, which comprises fabric, waterproof and moisture-permeable membrane 3, and eco-friendly adhesive. The fabric includes outer layer 1 and inner layer s 2, 4. The waterproof and moisture-permeable membrane 3 is closely bonded with the inner layers 2, 4 of the fabric. The outer layer 1 and inner layer 2 of the fabric are closely bonded together through eco-friendly adhesive. The eco-friendly adhesive is bonded with the fabric in a mesh structure. The eco-friendly adhesive includes liquid adhesive or powder adhesive. The shoe upper is shaped by heating, and the heating methods include vacuum heating, electric heating or steam heating.

In some embodiment, the inner layer of the fabric comprises two pieces of fabric, the waterproof and moisture-permeable membrane 3 is closely bonded between the two pieces of fabric in the inner layer of the fabric through heat sealing, and the eco-friendly adhesive is bonded to the connection between the inner layer 2 of the fabric and the outer layer 1 of the fabric in a mesh structure.

In some embodiment, the two pieces of fabric in the inner layer of the fabric comprise an inner layer 2 of the fabric in contact with outer layer 1 of the fabric and an inner layer 4 of the fabric closest to the instep. In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature. Thus, due to the eco-friendly adhesive pasted and formed in the mesh structure, the inner layer and the outer layer are bonded tightly together. In addition, the moisture is permeable via the gaps of the mesh structure.

In some embodiment, the mesh structure includes lattice and rhombic, and the eco-friendly adhesive forms lattice and rhombic edges.

In some embodiment, the shoe upper is sleeved outside the shoe last of the corresponding specification to form a 3D assembly, and the 3D assembly is heated and shaped by the vacuum forming method to obtain a three-dimensional shaped upper.

In some embodiment, from the outside to the inside, the shoe upper comprises the outer layer 1 of the fabric, the inner layer 2 of the fabric in contact with outer layer 1 of the fabric, the waterproof and moisture-permeable membrane 3, and the inner layer 4 of the fabric closest to the instep. The shoe upper is sleeved outside the shoe last of the corresponding specification to form a 3D assembly. The 3D assembly is heated by the vacuum forming method. The eco-friendly adhesive melts when heated, and is closely bonded with the fabric and the waterproof and moisture-permeable membrane 3.

In some embodiment, the outer layer 1 of the fabric has anti-wicking treatment.

In some embodiment, the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure. The flat woven or knitted fabric comprises seamless fabric.

In some embodiment, the dense structure is warp knitted closed pillar stitch, and 75 d recycled polyester fiber filaments are fully knitted under the guidance of a guard bar. The small mesh structure, the medium mesh structure and the large mesh structure are not directly connected, but are transiently connected through a dense structure. In some embodiment, the transition connection section is ≥2 loop column widths or 2 loop column lengths. And, the inner fabric is a light and thin fabric with Martindale abrasion resistance≥20000 revolutions. The small mesh structure, the medium mesh structure and the large mesh structure are warp knitted by the combination of two half jacquard guard bars and a conventional guard bar guiding 75 d-300 d recycled polyester fiber filament. The mesh length of the small mesh structure, the medium mesh structure and the large mesh structure differs by at least one loop column width or one loop column length.

The invention also provides a method for preparing a three-dimensional flexing resistance waterproof and moisture-permeable shoe upper, comprising: step (1), preparing the above-mentioned outer layer 1 of the fabric, the waterproof and moisture-permeable membrane 3 and the inner layers 2, 4 of the fabric; step (2), performing anti-wicking treatment on the outer layer 1 of the fabric; step (3), the waterproof and moisture-permeable membrane 3 is closely bonded between the two pieces of fabric in the inner layer of the fabric through heat sealing; step (4), In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by the vacuum forming method, the eco-friendly adhesive melts when heated, and is closely bonded with the fabric and the waterproof and moisture-permeable membrane 3.

In some embodiment, in the vacuum forming method a heating temperature is 300° C., and a heating time is 10 s.

### Embodiment 4

A three-dimensional flexing resistance waterproof and moisture-permeable shoe upper, which comprises fabric, waterproof and moisture-permeable membrane 3, and eco-friendly adhesive. The fabric includes outer layer 1 and inner layers 2, 4. The waterproof and moisture-permeable membrane 3 is closely bonded with the inner layer of the fabric. The outer layer 1 and inner layer 2 of the fabric are closely bonded together through eco-friendly adhesive. The eco-friendly adhesive is bonded with the fabric in a mesh structure. The eco-friendly adhesive includes liquid adhesive and powder adhesive. The shoe upper is shaped by heating, and the heating methods include vacuum heating, electric heating and steam heating.

In some embodiment, the inner layer of the fabric is a sock composed of fiber fabric, and the waterproof and moisture-permeable membrane 3 is closely fitted with the sock through heat sealing.

In some embodiment, the shoe upper is sleeved outside the shoe last of the corresponding specification to form a 3D assembly, and the 3D assembly is heated and shaped by the vacuum forming method to obtain a three-dimensional shaped upper.

In some embodiment, the outer layer 1 of the fabric has anti-wicking treatment.

In some embodiment, the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure. The flat woven or knitted fabric comprises seamless fabric.

In some embodiment, the dense structure is warp knitted closed pillar stitch, and 75 d recycled polyester fiber filaments are fully knitted under the guidance of a guard bar. The small mesh structure, the medium mesh structure and the large mesh structure are not directly connected, but are transiently connected through a dense structure. In some embodiment, the transition connection section is ≥2 loop column widths or 2 loop column lengths. And, the inner fabric is a light and thin fabric with Martindale abrasion resistance≥20000 revolutions. The small mesh structure, the medium mesh structure and the large mesh structure are warp knitted by the combination of two half jacquard guard bars and a conventional guard bar guiding 75 d-300 d recycled polyester fiber filament. The mesh length of the small mesh structure, the medium mesh structure and the large mesh structure differs by at least one loop column width or one loop column length.

The invention also provides a method for preparing a three-dimensional flexing resistance waterproof and moisture-permeable shoe upper, comprising: step (1), preparing the above-mentioned outer layer 1 of the fabric, the waterproof and moisture-permeable membrane 3 and the inner layers 2, 4 of the fabric; step (2), performing anti-wicking treatment on the outer layer 1 of the fabric; step (3), the waterproof and moisture-permeable membrane 3 is closely bonded between the two pieces of fabric in the inner layer of the fabric through heat sealing; step (4), In the hot-melt state, the eco-friendly adhesive is bonded to the inner layer 2 of the fabric in contact with outer layer 1 of the fabric in a mesh structure. After the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by the vacuum forming method, the eco-friendly adhesive melts when heated, and is closely bonded with the fabric and the waterproof and moisture-permeable membrane.

In some embodiment, in the vacuum forming method a heating temperature is 180° C., and a heating time is 30 s.

Although the disclosure has been disclosed and illustrated with reference to particular embodiments, the principles involved are susceptible for use in numerous other embodiments that will be apparent to a person having ordinary skill in the art. This disclosure is, therefore, to be limited only as indicated by the scope of the appended claims.

What is claimed is:

1. A three-dimensional flexing resistance waterproof and moisture-permeable shoe upper, which comprises fabric, waterproof and moisture-permeable membrane, and eco-friendly adhesive; wherein the fabric includes outer layer and inner layer, the waterproof and moisture-permeable membrane is closely bonded with the inner layer of the fabric; the outer layer and inner layer of the fabric are closely bonded together through eco-friendly adhesive; the eco-friendly adhesive is bonded with the fabric in a mesh structure, and the eco-friendly adhesive includes liquid adhesive or powder adhesive; the shoe upper is shaped by heating, and the heating methods include vacuum heating, electric heating or steam heating.

2. The three-dimensional flexing resistance waterproof and moisture-permeable shoe upper according to claim 1, wherein the inner layer of the fabric comprises two pieces of fabric, the waterproof and moisture-permeable membrane is closely bonded between the two pieces of fabric in the inner layer of the fabric through heat sealing, and the eco-friendly adhesive is bonded to the connection between the inner layer of the fabric and the outer layer of the fabric in a mesh structure.

3. The three-dimensional flexing resistance waterproof and moisture-permeable shoe upper according to claim 2, wherein the two pieces of fabric in the inner layer of the fabric comprise an inner layer of the fabric in contact with outer layer of the fabric and an inner layer of the fabric closest to the instep; in the hot-melt state, the eco-friendly adhesive is bonded to the inner layer of the fabric in contact with outer layer of the fabric in a mesh structure; after the bonding is completed, the eco-friendly adhesive in the mesh structure is cooled, solidified and tightly bonded to the fabric under the room temperature.

4. The three-dimensional flexing resistance waterproof and moisture-permeable shoe upper according to claim 2, wherein the mesh structure includes lattice or rhombic, and the eco-friendly adhesive forms the edges of the lattice or rhombic.

5. The three-dimensional flexing resistance waterproof and moisture-permeable shoe upper according to claim 3, wherein the shoe upper is sleeved outside the shoe last of the corresponding specification to form a 3D assembly, and the 3D assembly is heated and shaped by a vacuum forming method to obtain a three-dimensional shaped upper.

6. The three-dimensional flexing resistance waterproof and moisture-permeable shoe upper according to claim 3, wherein from the outside to the inside, the shoe upper comprises the outer layer of the fabric, the inner layer of the fabric in contact with outer layer of the fabric, the waterproof and moisture-permeable membrane, and the inner layer of the fabric closest to the instep; the shoe upper is sleeved outside the shoe last of the corresponding specification to form a 3D assembly; the 3D assembly is heated by a vacuum forming method; the eco-friendly adhesive melts when heated, and is closely bonded with the fabric and the waterproof and moisture-permeable membrane.

7. The three-dimensional flexing resistance waterproof and moisture-permeable shoe upper according to claim 1, wherein the outer layer of the fabric has anti-wicking treatment.

8. The three-dimensional flexing resistance waterproof and moisture-permeable shoe upper according to claim 1, wherein the fabric comprises a base fabric, a warp knitted jacquard fabric and a flat woven or knitted fabric, the base fabric comprises a regular mesh fabric and a plain fabric, the warp knitted jacquard fabric is a regional engineering mesh structure, and the regional engineering mesh structure comprises a dense structure, a small mesh structure, a medium mesh structure and a large mesh structure; the flat woven or knitted fabric comprises seamless fabric.

9. A method for preparing the three-dimensional flexing resistance waterproof and moisture-permeable shoe upper according to claim 1, comprising: step (1), preparing the above-mentioned outer layer of the fabric, the waterproof and moisture-permeable membrane and the inner layer of the fabric; step (2), performing anti-wicking treatment on the outer layer of the fabric; step (3), the waterproof and moisture-permeable membrane is closely bonded between the two pieces of fabric in the inner layer of the fabric through heat sealing; step (4), in the hot-melt state, the eco-friendly adhesive is bonded to the inner layer of the fabric in contact with outer layer of the fabric in a mesh structure; after the bonding is completed, the eco-friendly adhesive in the mesh structure is cooled, solidified and tightly bonded to the fabric under room temperature; step (5), the shoe upper is sleeved outside the shoe last of the corresponding specification to form a 3D assembly, and the 3D assembly is heated by a vacuum forming method, the eco-friendly adhesive melts when heated, and is closely bonded with the fabric and the waterproof and moisture-permeable membrane.

10. The method for preparing the three-dimensional flexing resistance waterproof and moisture-permeable shoe upper according to claim 9, wherein in the vacuum forming method a heating temperature is 100° C.-300° C., and a heating time is 10 s-100 s.
